(19) United States
(12) Patent Application Publication
(10) Pub. No.: US 2020/0308883 A1
(43) Pub. Date: Oct. 1, 2020

(54) DOOR HANDLE ASSEMBLY OF A VEHICLE DOOR

(71) Applicant: HUFHÜLSBECK & FÜRST GMBH & CO., Velbert (DE)

(72) Inventors: Christian Bresser, Leichlingen (DE); Michael Rhein, Moenchengladbach (DE); Bernd Reifenberg, Essen (DE)

(73) Assignee: Huf Huelsbeck & Fuerst GmbH & Co. KG, Velbert (DE)

(21) Appl. No.: 16/771,568

(22) PCT Filed: Oct. 19, 2018
(86) PCT No.: PCT/EP2018/078699

§ 371 Date: Jun. 10, 2020

(30) Foreign Application Priority Data
Dec. 14, 2017 (DE) 10 2017 130 029.5

(51) Int. Cl. E05B 85/10; E05B 81/90; E05B 85/14

(52) U.S. Cl. CPC E05B 85/107; E05B 81/90; E05Y 2900/531; E05B 85/103; E05B 85/14

(57) ABSTRACT

A door handle assembly of a vehicle door includes a handle support, a handle which is mounted on the handle support and runs flush with the outer contour of the vehicle door in a non-use position and is movable into an actuation position, a first lifting mechanism and a second lifting mechanism. Each lifting mechanism is coupled to the handle so as to transmit a movement. The handle is protruded relative to the outer contour of the vehicle door in the actuation position in comparison to the non-use position and can be actuated by the user in order to open the vehicle door. The first lifting mechanism has a first pivot axis which is arranged on the handle support. The first lifting mechanism and the second lifting mechanism form a scissor kinematic system and are coupled together so as to transmit a movement.

The invention relates to a door handle assembly of a vehicle door, having a handle support which can be secured to the vehicle door, a handle having a longitudinal extension and being mounted on the handle support and arranged so as to run flush with the outer contour of the vehicle door in a non-use position and being designed to be movable into an actuation position by a user for actuation, and a first lever mechanism which is coupled to the first longitudinal end of the handle so as to transmit a movement, and a second lever mechanism which is coupled to the second longitudinal end of the handle so as to transmit a movement, wherein the handle is arranged so as to protrude relative to the outer contour of the vehicle door in the actuation position in comparison to the non-use position and can be actuated by the user in order to open the vehicle door, and wherein the first lever mechanism has a first pivot axis which is arranged on the handle support.

Door handle assemblies in which the handle extends flush with the outer contour of the vehicle door in its non-use position are known from the prior art. The handle may thereby be designed as an inner or outer handle in the case of these types of door handle assemblies for a vehicle door of a motor vehicle, wherein the present invention relates to a door handle assembly for an outer handle. For this type of door handle assembly, there is a variety of different constructions and embodiments. The door handle assembly according to the invention relates to such constructions in which a handle support is secured to the rear of the vehicle door, i.e. inside the motor vehicle. In such embodiments, the handle attached to the handle support usually protrudes from the vehicle door and disturbs both the aesthetic impression of the vehicle and the vehicle aerodynamics. In order to avoid these disadvantages, there are known prior art door handle assemblies in which the outside of the handle in its non-use position, i.e. in which it is not used, extends approximately flush with the outer contour of the vehicle door, i.e. flush with the edge. Such a handle can be transferred to an actuation position for opening the vehicle door or an on-board lock, in which the handle protrudes compared to the outer contour of the vehicle door. The handle is extended using a motor when a legitimate user approaches the vehicle. Once the handle is no longer needed, it returns to the non-use position and disappears into the vehicle body to avoid producing air resistance. As is known, the movement of the handle is realized with the aid of a first lever mechanism and a second lever mechanism, which couple the respective longitudinal ends of the handle to the handle support. A disadvantage of such door handle assemblies of the type described at the outset is the limited installation space, since the overall depth of the door, i.e. the extension from the outside of the door to the inside of the door, generally also has to take into account the depth which is required so that the window pane can be guided past the handle support when it is opened and the lever mechanism does not get into the movement path of the window pane during a movement of the handle from the non-use position into the actuation position. The depth for countersinking the window pane can hardly be reduced, so that the installation depth of the door handle assembly decisively determines the overall depth of the door.

The invention has for its object to develop a door handle assembly of a vehicle door in a structurally simple and inexpensive manner, which has a small installation depth and through which the overall depth of the door can be reduced.

In a door handle assembly of the type described in the introduction, this object is achieved according to the invention in that the first lever mechanism and the second lever mechanism form a scissor kinematic system and are coupled together so as to transmit a movement.

Advantageous and expedient embodiments and developments of the invention are disclosed in the dependent claims.

The invention provides a door handle assembly in a structurally simple and inexpensive manner, by means of which the overall depth of the door can be reduced to a minimum. Because the first lever mechanism and the second lever mechanism form a scissor kinematic system and are coupled together so as to transmit a movement, it is possible to accommodate the required kinematic processes in the smallest and tightest installation space, which are necessary for moving the handle from the non-use position to the actuation position and back to the non-use position. The scissor kinematic system formed by the first lever mechanism and the second lever mechanism increases the efficiency of the door handle assembly according to the invention, because this design has a high degree of rigidity with increased acceleration values for the movement of the handle in comparison to known door handle assemblies, wherein the movement of the door handle arrangement according to the invention takes place at a high level of accuracy.

In terms of a low installation depth, it is structurally particularly favorable if, in an embodiment of the invention, the first lever mechanism has a first joint axis which is arranged at the first longitudinal end of the handle and which is coupled to the first pivot axis, the second lever mechanism having a second pivot axis which is arranged on the handle support, and a second pivot axis, which is arranged at the second longitudinal end of the handle and which is coupled to the second pivot axis so as to transmit a movement.

With regard to an advantageous dynamic of the door handle assembly, the invention further provides that a first coupling lever is pivotably mounted on the second pivot axis and a second coupling lever is rotatably connected to the second joint axis, wherein a connecting joint rotatably connects the first coupling lever and the second coupling lever to one another, and wherein in the non-use position of the handle, the first coupling lever and the second coupling lever are arranged on the connecting joint at an acute angle to one another.

A small installation depth can also be achieved in an embodiment of the invention by arranging the first coupling lever and the second coupling lever on the connecting joint at an obtuse angle to one another in the actuation position of the handle.

A mechanical and constructive simplification of the second lever mechanism with regard to actuation of the handle can be realized in an embodiment of the invention in that the second coupling lever has two lever portions which are articulated via an intermediate joint, wherein the two lever portions in the non-use position and the actuation position extend linearly and the two lever portions are designed to be pivotable relative to one another on the intermediate joint in the actuation position as a result of actuation of the handle by the user.

It is advantageous for a small installation space in the longitudinal direction of the handle if, in a further embodiment of the invention, the second coupling lever, the second joint axis and the connecting joint are arranged within the longitudinal extension of the handle, wherein the connecting joint is arranged between the first pivot axis and the second pivot axis.

To couple the movement of the first lever mechanism with the second lever mechanism, the invention provides that the connecting joint is coupled to the first lever mechanism via a coupling rod so as to transmit a movement, with the coupling rod being designed to move the connecting joint in the direction of the second pivot axis when the handle moves from the non-use position into the actuation position. In this way, there is also advantageously a small installation space in the longitudinal direction of the handle.

According to a first embodiment, the invention provides that the first lever mechanism is diamond-shaped and has a first diamond lever, a second diamond lever, a third diamond lever and a fourth diamond lever, wherein the first diamond lever and the second diamond lever are rotatably mounted on the first pivot axis and the third diamond lever and the fourth diamond lever are rotatably mounted on the first joint axis, and wherein the first diamond lever and the third diamond lever are rotatably connected to one another via a first diamond joint axis and the second diamond lever and the fourth diamond lever are rotatably connected to one another via a second diamond joint axis. The scissor shape designed in this way for the first lever mechanism only requires a small installation depth, but is nevertheless able to carry out accelerated movements with the highest degree of precision.

In an embodiment of the first embodiment, the invention further provides that the first pivot axis and the first joint axis are arranged opposite each other in a direction transverse to a longitudinal direction of the handle, wherein the coupling rod is connected to the first diamond joint axis and is movably guided by the second diamond joint axis in the longitudinal direction of the handle.

In an embodiment of the first embodiment, it is structurally favorable when both the first diamond lever and the second diamond lever are arranged on the first pivot axis and the third diamond lever and the fourth diamond lever on the first joint axis are arranged at an obtuse angle to each other in the non-use position of the handle, wherein both the first diamond lever and the second diamond lever are arranged on the first pivot axis and the third diamond lever and the fourth diamond lever are arranged on the first joint axis at an acute angle to each other in the actuation position of the handle. This configuration allows a minimal installation space for both positions of the handle.

It is also advantageous for a minimal installation space in the design of the first embodiment if the first diamond lever and the third diamond lever are arranged on the first diamond joint axis in the non-use position of the handle and the second diamond lever and the fourth diamond lever are arranged on the second diamond joint axis at an acute angle to one another, wherein the first diamond lever and the third diamond lever are arranged on the first diamond joint axis in the actuation position of the handle and the second diamond lever and the fourth diamond lever are arranged on the second diamond joint axis at an obtuse angle to one another.

The installation space can advantageously be kept small if, in the embodiment of the first embodiment, the first lever mechanism is arranged within the longitudinal extension of the handle, the second diamond joint axis being arranged between the first diamond joint axis and the connecting joint.

In a design of the invention for a second embodiment, the invention provides that the first lever mechanism has a guide lever and a movement lever, wherein the guide lever is rotatably connected to the first joint axis and rotatably connected to a movement axis which is linearly movable on the handle support, and wherein the guide lever is rotatably mounted on the first pivot axis and is rotatably connected to the central portion of the movement lever via a joint point.

In an embodiment of the second embodiment, the invention provides for a small installation depth that, when the handle is in the non-use position, the guide lever and the portion of the movement lever located between the joint point and the first articulation axis are arranged at an acute angle at the joint point, wherein in the actuation position of the handle of the guide lever and the portion of the movement lever connected to the first joint axis are arranged at the joint point at an obtuse angle to one another.

In an embodiment of the second embodiment, it is advantageous for a small installation space of the door handle assembly if the joint point is arranged lying between the movement axis and the first pivot axis, the coupling rod being rotatably connected to the joint point, wherein the movement axis moves during a movement of the handle from the non-use position into the actuation position in the direction of the first pivot axis and the movement axis presses the joint point in the direction of the second pivot axis.

In an embodiment of the invention, the invention provides for a third embodiment that the first lever mechanism has a joint point with which the coupling rod is rotatably connected, a guide lever which is rotatably mounted on the first pivot axis and which is rotatably connected to the joint point, a movement lever which is rotatably mounted on the joint point and has a first movement arm and a second movement arm, and a drive lever which is mounted on a third pivot axis which is arranged on the handle support, wherein the drive lever is connected to the first movement arm via a joint connection, the second movement arm being connected to the first joint axis.

With regard to a minimal installation space, the invention provides in an embodiment of the third embodiment that the first movement arm and the second movement arm are oriented at an angle to one another, wherein in the non-actuation position of the handle, the second movement arm and the guide lever are arranged at the joint point at an acute angle to one another, and wherein in the actuation position of the handle, the second movement arm and the guide lever are arranged at the joint point at an obtuse angle to one another.

Finally, in a further embodiment of the third embodiment, the invention provides that the third pivot axis is arranged lying between the first pivot axis and the joint connection, wherein the joint connection moves against an opening direction of the handle when the handle moves from the non-use position into the actuation position and the articulation connection presses the joint point in the direction of the second pivot axis.

In the sense of the invention, an acute angle means an angle of less than 90°, whereas an obtuse angle means an angle between 90° and 180° in the sense of the invention.

It is self-evident that the features mentioned above and yet to be described below can be used not only in the combination described but also in other combinations or in isolation without departing from the scope of the present invention. The scope of the invention is defined only by the claims.

Other details, features, and advantages of the subject matter of the invention can be found in the following description in connection with the drawing, in which preferred embodiments of the invention are presented by way of example. In the drawings:

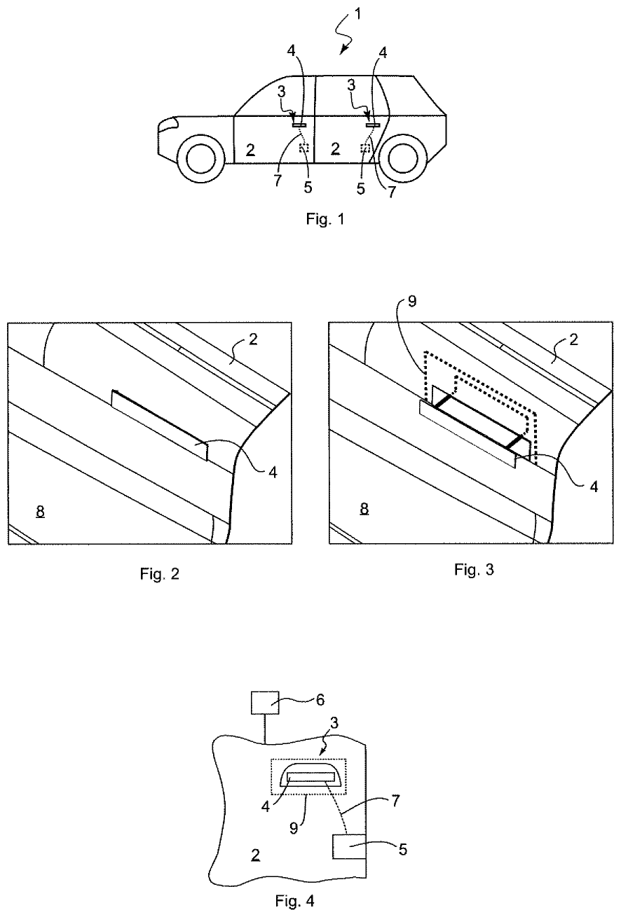

FIG. 1 is a side view of a motor vehicle having a door handle assembly according to the invention,

FIG. 2 is a perspective view of a vehicle door of the motor vehicle, in which a handle of the door handle assembly according to the invention is arranged flush with an outer contour of the vehicle door in a non-use position,

FIG. 3 is a perspective view of the vehicle door of the motor vehicle, in which the handle of the door handle assembly according to the invention is arranged in an actuation position in which the handle is displaced parallel to the non-use position and protrudes with respect to the outer contour of the vehicle door,

FIG. 4 is a schematic illustration of the vehicle door having the door handle assembly arranged thereon, a door lock and a locking system,

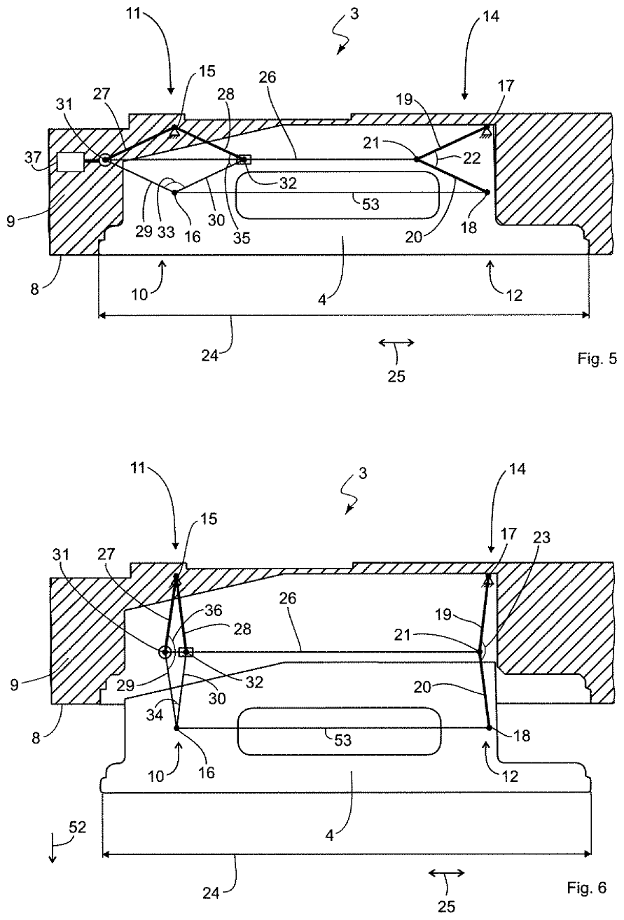

FIG. 5 is a schematic top view of a door handle assembly according to a first embodiment of the invention, in which the handle is arranged in the non-use position,

FIG. 6 is a schematic top view of the door handle assembly according to the first embodiment of the invention, in which the handle is arranged in the actuation position,

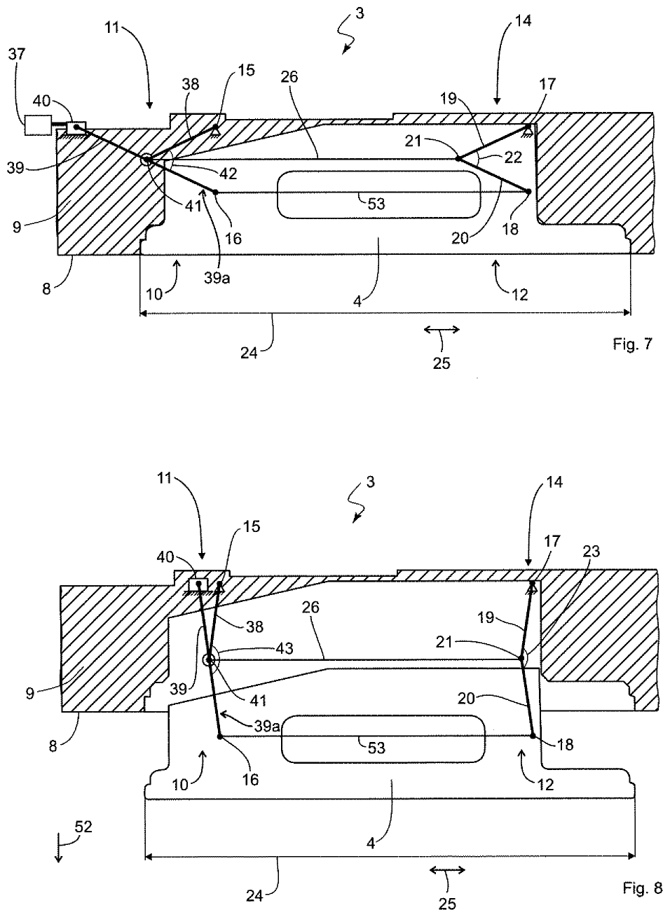

FIG. 7 is a schematic top view of a door handle assembly according to a second embodiment of the invention, in which the handle is arranged in the non-use position,

FIG. 8 shows a schematic top view of the door handle assembly according to the second embodiment of the invention, in which the handle is arranged in the actuation position,

FIG. 9 shows a schematic top view of the door handle assembly according to the second embodiment of the invention, in which the handle is arranged actuated by a user from the actuation position,

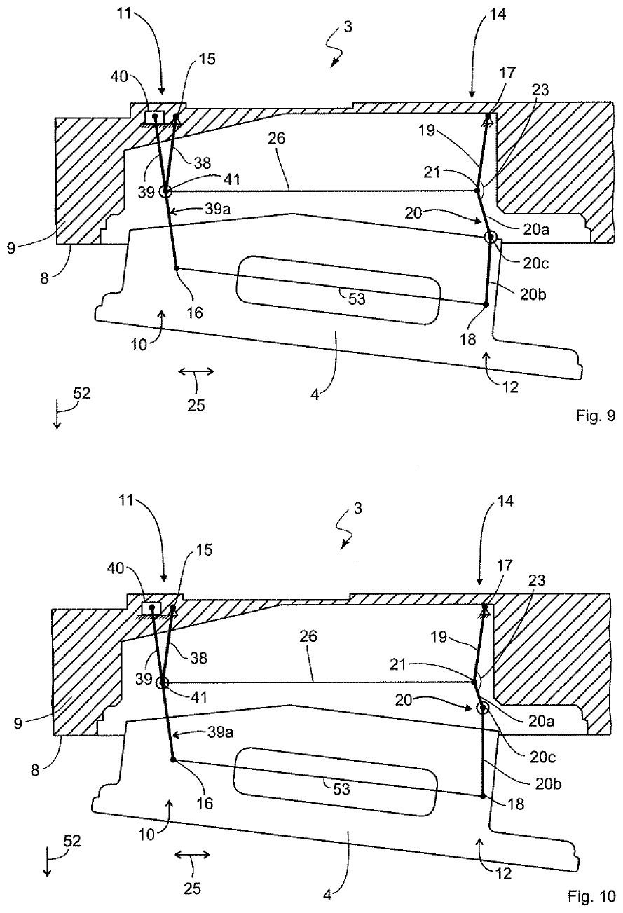

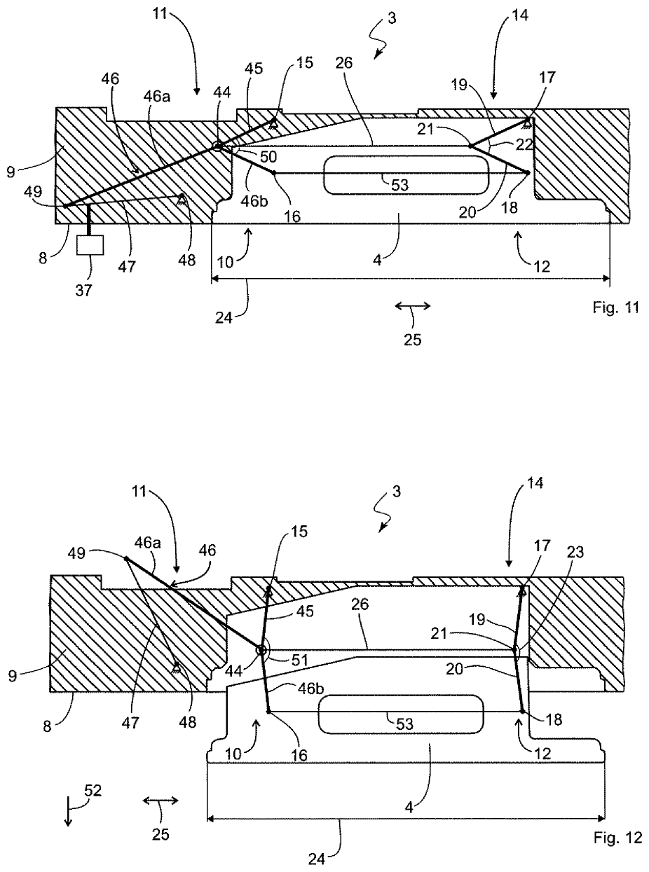

FIG. 10 shows a schematic top view of the door handle assembly according to the second embodiment of the invention, in which the handle is arranged actuated by a user from the actuation position,

FIG. 11 is a schematic top view of a door handle assembly according to a third embodiment of the invention, in which the handle is arranged in the non-use position, and

FIG. 12 is a schematic plan view of the door handle assembly according to the third embodiment of the invention, in which the handle is arranged in the actuation position.

FIG. 1 shows a vehicle or motor vehicle 1 in the form of a car by way of example having four doors 2 in the example (two of which can be seen in FIG. 1), which can be opened via a door handle assembly 3 and in particular with the aid of a handle 4. With reference to FIGS. 1 to 3, the doors 2 are closed by respective door locks 5 and can be opened from the outside by a respective actuation of the handle 4. The handle 4 is actuated to open the door lock 5, the actuation in the exemplary embodiments shown in the drawings being a pulling force exerted by the user on the handle 4. To open the door 2, the handle 4 is then either pulled in normal operation or the handle 4 is pivoted to a specific degree, whereby a switch is actuated, which in turn activates an electromechanical locking system 6 (see FIG. 4), with the aid of which the door lock 5 can then be opened electrically. When the handle 4 is actuated to electrically open the door lock 5, the handle 4 is moved out of an actuation position. The electrical opening can take place before the end position of the handle 4 is reached. In the case of a current-operated normal operation, a slight pulling movement on the handle 4 is consequently sufficient for a Bowden cable system 7, which is shown in FIG. 1 by way of example, to be operated electrically for unlocking the door lock 5. In the case of a currentless emergency operation, the door handle assembly 3 can be formed such that manual unlocking of the door lock 5 and thereby manual opening of the vehicle door 2 is possible by actuation of the handle 4 effected by a user, wherein the handle 4 must be deflected or actuated past the deflection which is necessary in the normal operation. FIG. 2 is a perspective view of one of the vehicle doors 2 and the handle 4 which serves for the opening of the vehicle door 2. In FIG. 2, the handle 4 is arranged approximately flush with the outer contour 8 of the vehicle door 2, i.e. flush with the edge, when the door handle assembly 3 is installed in the vehicle door 2. In this position the handle 4 is in a non-use position in which it is not used. From the non-use position shown in FIG. 2 it is possible to transfer the handle 4 to an actuation position shown in FIG. 3 in which it protrudes compared to the outer contour 8 of the vehicle door 2, such that the handle 4 is arranged in its actuation position to protrude from the vehicle door 2. In this protruding actuation position or when extended from the outer contour 8, a user can reach behind the handle 4 and actuate or handle to open the vehicle door 2 or unlock the vehicle door lock 5. According to the present invention, the handle 4 is transferred from the non-use position into the actuation position in a current-operated normal operation by means of a suitable drive means, wherein for the current-operated normal operation, proximity sensors or other sensors may be provided to move the handle 4 from the flush or flush-mounted non-use position to the actuation position as soon as a user approaches the door handle assembly 3 or handle 4. It can be seen from FIG. 3 that the handle 4 arranged in its actuation position is arranged on the outside on the door 2 of the motor vehicle 1, wherein the handle 4 can be gripped from behind by a user. The handle 4 is thus arranged so as to protrude relative to the outer contour 8 of the vehicle door 2 in the actuation position in comparison to the non-use position and can be actuated by the user in order to open the vehicle door 2. To couple the handle 4 to the vehicle door 2, a frame-like handle support 9 is provided, which is only shown schematically and in dashed lines in FIG. 3, since it is arranged on the inside of the vehicle door 2 and thus covered by the vehicle door 2 in FIGS. 1 and 2. The handle support 9 is secured to the inside of the vehicle door 2 via known securing means and supports the handle 4. In other words, the handle support 9, which can be secured to the vehicle door 2, is known to be used for attaching and mounting the handle 4 and is secured to the inside of the door 2 by means of screw connections (not shown in detail).

FIGS. 5 to 12 show different embodiments of the door handle assembly 3 according to the invention, wherein FIGS. 5 and 6 show a first embodiment, FIGS. 7 to 10 show a second embodiment and FIGS. 11 and 12 show a third embodiment. All three embodiments have in common that a first longitudinal end 10 of the handle 4 mounted on the handle support 9 is coupled to a first lever mechanism 11 so as to transmit a movement and a second longitudinal end 12 of the handle 4 is coupled to a second lever mechanism 14 so as to transmit a movement. In all three embodiments, the first lever mechanism 11 has a first pivot axis 15, which is arranged in a stationary manner on the handle support 9, the first pivot axis 15 alternatively also being able to be arranged on the vehicle door 2. Due to the fixed attachment to the handle support 9 or alternatively to the vehicle door 2, the mechanical symbol of a fixed bearing is used for the first pivot axis 15 in the drawings. Furthermore, the first lever mechanism 11 has a first joint axis 16 which is arranged at the first longitudinal end 10 of the handle 4 and which is coupled to the first pivot axis 15 so as to transmit a movement. The first joint axis 16 is mounted on the handle 4, so that the first joint axis 16 is moved with the handle 4 when the handle 4 moves from the non-actuation position into the actuation position. Furthermore, in all three embodiments, the second lever mechanism 14 has a second pivot axis 17, which is arranged fixed on the handle support 9 or alternatively on the vehicle door 2, which is why a fixed bearing is used as an example as a mechanical symbol for the second pivot axis 17 in the drawings. The second pivot axis 17 also includes a second joint axis 18 which is arranged at the second longitudinal end 12 of the handle 4 and which is moved with the handle 4 when the handle 4 is moved, the second joint axis 18 being coupled to the second pivot axis 17 so as to transmit a movement. In all of the embodiments shown in the drawings, the second lever mechanism 14 further comprises a first coupling lever 19 and a second coupling lever 20. The first coupling lever 19 is pivotally mounted on the second pivot axis 17, whereas the second coupling lever 20 is rotatably connected to the second joint axis 18. Furthermore, the second lever mechanism 14 has a connecting joint 21 which is movable relative to the handle 4 and the handle support 9. The connecting joint 21 rotatably connects the first coupling lever 19 to the second coupling lever 20. In the non-use position of the handle 4, the first coupling lever 19 and the second coupling lever 20 are arranged on the connecting joint 21 at an acute angle 22, i.e. an angle of less than 90°, to one another (see FIGS. 5, 7 and 11), whereas in the actuation position the handle 4, the first coupling lever 19 and the second coupling lever 20 are arranged on the connecting joint 21 at an obtuse angle 23, i.e. an angle between 90° and 180°, to one another (see FIGS. 6, 8 and 12). Consequently, the first coupling lever 19 and the second coupling lever 20 are spread when the handle 4 moves from its non-use position into its actuation position. As can also be seen from the drawings for the various embodiments, the second pivot axis 17, the first coupling lever 19, the second coupling lever 20, the second joint axis 18 and the connecting joint 21 are arranged within the longitudinal extension 24 of the handle 4, wherein the connecting joint 21 is arranged between the first pivot axis 15 and the second pivot axis 17. The longitudinal extension 24 of the handle 4 corresponds to the length of the handle 4 in a longitudinal direction 25 of the handle 4, as shown in the drawings. Finally, all embodiments have in common that the connecting joint 21 of the second lever mechanism 14 is connected to the first lever mechanism 11 via a coupling rod 26 and is coupled so as to transmit a movement. Accordingly, when the handle 4 moves from the non-use position into the actuation position, the coupling rod 26 and the connecting joint 21 are designed to move in the direction of the second pivot axis 17. In other words, the coupling rod 26 presses the connecting joint 21 in the direction of the second pivot axis 17 in order to move the handle 4 from the non-use position into the actuation position. In the three embodiments, a connecting lever 53 is provided on the handle 4, which is rotatably supported at the end on the first joint axis 16 and the second joint axis 18. The connecting lever 53 is purely optional and serves to a certain degree for stabilization.

Before the various configurations of the first lever mechanism 11 are described, the alternatives for an embodiment of the second coupling lever 20 shown in FIGS. 9 and 10 are discussed below. FIGS. 9 and 10 each show a position of the handle 4, in which the handle 4 was actuated by a user from the actuation position and has therefore assumed a position in which the handle 4 is arranged obliquely to the longitudinal direction 25. According to FIGS. 9 and 10, when the handle 4 is actuated, configurations are conceivable by which the handle 4 is moved further out of the vehicle door 2 at its second longitudinal end 12 than at its first longitudinal end 10, which may be necessary, for example, in the case of a mechanical emergency actuation to operate the Bowden cable system 7 manually. For this purpose, it is conceivable that the second coupling lever 20 has two lever portions 20a and 20b which are connected to one another in an articulated manner via an intermediate joint 20c. In the non-use position and the actuation position, the two lever portions 20a and 20b extend linearly, so that there is a straight-line coupling lever, as is shown, for example, in FIGS. 7 and 8. On the other hand, the intermediate joint 20c allows the two lever portions 20a, 20b on the intermediate joint 20c to be pivoted relative to one another when the handle 4 is actuated by a user in the actuation position, as shown in FIGS. 9 and 10.

The above description for the design of the second lever mechanism 14 is valid for all of the embodiments shown in the drawings, the particulars present for the individual embodiments being described below. It should be noted here that in the sense of the invention the expression “rotatably connected to one another” means a joint connection of two elements, such that the two elements can be freely rotated relative to one another, but are nevertheless coupled to one another by a joint element.

It can be seen from FIGS. 5 and 6, which relate to the first embodiment of the door handle assembly 3, that the first lever mechanism 11 is designed to be diamond-shaped. Correspondingly, the first lever mechanism 11 has a first diamond lever 27, a second diamond lever 28, a third diamond lever 29 and a fourth diamond lever 30, the first diamond lever 27 and the second diamond lever 28 being rotatably mounted on the first pivot axis 15 and the third diamond lever 29 and the fourth diamond lever 30 being rotatably mounted on the first joint axis 16. Furthermore, the first diamond lever 27 and the third diamond lever 29 are rotatably connected to one another via a first diamond joint axis 31, whereas the second diamond lever 28 and the fourth diamond lever 30 are rotatably connected to one another via a second diamond joint axis 32. To form the diamond shape, the first pivot axis 15 and the first joint axis 16 are arranged opposite one another in a direction transverse to the longitudinal direction 25 of the handle 4. The coupling rod 26 is also connected to the first diamond joint axis 31, the coupling rod being movably guided by the second diamond joint axis 32 in the longitudinal direction 25 of the handle 4. The first diamond joint axis 31 and the second diamond joint axis 32 lie opposite one another in the longitudinal direction 25 and move towards one another when the handle 4 is moved from the non-actuation position into the actuation position.

As can be seen in FIG. 5, when the handle 4 is not in use, both the first diamond lever 27 and the second diamond lever 28 on the first pivot axis 15 and the third diamond lever 29 and the fourth diamond lever 30 on the first joint axis 16 are at an obtuse angle 33 to each other (in FIG. 5, the obtuse angle 33 is shown only for the sake of clarity on the first joint axis 16), whereas in the non-use position of the handle 4, both the first diamond lever 27 and the third diamond lever 29 on the first diamond joint axis 31 and the second diamond lever 28 and the fourth diamond lever 30 on the second diamond joint axis 32 are arranged at an acute angle 35 to one another (in FIG. 5, for reasons of clarity, the acute angle 35 is only shown on the second diamond joint axis 32). For reasons of clarity, only the obtuse angle 33 on the first joint axis 16 and the acute angle 35 on the second diamond joint axis 32 are shown in FIG. 5.

In FIG. 6, which shows the actuation position of the handle 4, both the first diamond lever 27 and the second diamond lever 28 on the first pivot axis 15 and the third diamond lever 29 and the fourth diamond lever 30 on the first joint axis 16 are arranged at an acute angle 34 to one another (in FIG. 6, the acute angle 34 is only shown on the first articulated axis 16 for reasons of clarity), whereas the first diamond lever 27 and the third diamond lever 29 are arranged on the first diamond joint axis 31 and the second diamond lever 28 and the fourth diamond lever 30 are arranged on the second diamond joint axis 32 at an obtuse angle 36 to one another (in FIG. 6, for reasons of clarity, the obtuse angle 36 is only shown on the first diamond joint axis 31).

As can also be seen from FIGS. 5 and 6 for the first embodiment, the first lever mechanism 11 is arranged both in the non-use position and in the actuation position of the handle 4 within the longitudinal extension 24 of the handle 4, the second diamond joint axis 32 being arranged between the first diamond joint axis 31 and the connecting joint 21. When the handle 4 is moved from the non-use position shown in FIG. 5 to the actuation position shown in FIG. 6 in a current-operated normal operation of the door handle assembly 3, a drive element 37, which is only shown by way of example in FIG. 5, engages the first diamond joint axis 31 and moves the first diamond joint axis 31 in the direction of the second lever mechanism 14. The second diamond joint axis 32 guided by the coupling rod 26 moves in the opposite direction to the first diamond joint axis 31, the first diamond joint axis 31 and the second diamond joint axis 32 moving toward one another when the drive element 37 moves the handle 4 from the non-use position into the actuation position. When the handle 4 is moved, the diamond-shaped first lever mechanism 11 compresses, wherein the first diamond lever 27 and the third diamond lever 29 pivot about the first diamond joint axis 31 and the second diamond lever 28 and the fourth diamond lever 30 about the second diamond joint axis 32. The first diamond lever 27 and the third diamond lever 29 move towards the second diamond lever 28 and the fourth diamond lever 30, such that the diamond levers 27, 28, 29, 30 move the first joint axis 16 perpendicular to the longitudinal direction 25, as a result of which the handle 4 reaches the issued actuation position. Furthermore, the compression of the diamond levers 27, 28, 29, 30 and in particular the movement of the first diamond joint axis 31 leads to the coupling rod 26 moving in the direction of the second lever mechanism 14, as a result of which the first coupling lever 19 and the second coupling lever 20 are spread apart. As a result of this spreading, the second joint axis 18 likewise moves perpendicular to the longitudinal direction 25, such that the handle 4 is also moved out of the outer contour 8 at its second longitudinal end 12 and the handle 4 is arranged overall in the actuation position shown in FIG. 6. The return movement of the handle 4 back into the non-use position takes place in the reverse order.

FIGS. 7 and 8 show a second embodiment, which differs from the first embodiment in the configuration of the first lever mechanism 11, the second lever mechanism 14 being identical to the first embodiment. In the second embodiment, the first lever mechanism 11 has a guide lever 38 and a movement lever 39. The movement lever 39 is rotatably connected to the first joint axis 16 and rotatably to a movement axis 40 which is linearly movable on the handle support 9 (or alternatively on the vehicle door 2). Furthermore, the guide lever 38 is rotatably mounted on the first pivot axis 15, the guide lever 38 also being rotatably connected to the central portion of the movement lever 39 via a joint point 41. The joint point 41 is arranged lying between the movement axis 40 and the first pivot axis 15, the coupling rod 26 being rotatably connected to the joint point 41.

Referring to FIG. 7, in the non-use position of the handle 4 the guide lever 38 and the portion 39a of the movement lever 39 are arranged between the joint point 41 and the first joint axis 16 at the joint point 41 at an acute angle 42 to each other. As can be seen from FIG. 7, the first lever mechanism 11 has great similarities with the second lever mechanism 14. The acute angle 42 of the first lever mechanism 11 coincides with the acute angle 22 of the second lever mechanism 14, wherein the guide lever 38 and the portion 39a of the movement lever 39 are also oriented relative to one another between the joint point 41 and the first joint axis 16, as is the case with first coupling lever 19 to the second coupling lever 20.

A drive element 37, which is only indicated by way of example in FIG. 7, moves the movement axis 40 in the direction of the second lever mechanism 14 when the handle 4 is to be moved from the non-use position into the actuation position. During this movement, the movement axis 40 also moves in the direction of the first pivot axis 15, wherein the movement axis 40 presses the joint point 41 in the direction of the second pivot axis 17. As can be seen from FIG. 7, in the actuation position of the handle 4, the guide lever 38 and the portion 39a of the movement lever 39 connected to the first joint axis 16 are arranged at the joint point 41 at an obtuse angle 43 to one another, By shifting the joint point 41 from the position shown in FIG. 7 to the position shown in FIG. 8, the coupling rod 26 is pushed in the direction of the second lever mechanism 14, whereby the connecting joint 21 is forced in a direction pointing away from the first lever mechanism 11. The movement of the joint point 41 and the connecting joint 21 cause the guide lever 38 and the portion 39a of the movement lever 39 to spread, and cause the first coupling lever 19 and the second coupling lever 20 to spread.

FIGS. 9 and 10 show the second embodiment having modifications for the second lever mechanism 14, which has already been described above and to which reference is made here. FIGS. 9 and 10 relate to a position of the handle 4 when it is actuated by a user from the actuation position, such that the second longitudinal end 12 of the handle 4 is pivoted relative to the first longitudinal end 10, wherein the handle 4 pivots during an actuation by the user about the first joint axis 16. The variant of the second embodiment shown in FIGS. 9 and 10 thus describes a mechanism in which the second longitudinal end 12 of the handle 4 is designed to be pivotable about the first joint axis 16.

A third embodiment of the door handle assembly 3 according to the invention is shown by way of example in FIGS. 11 and 12. In this third embodiment, the first lever mechanism 11 has a joint point 44, a guide lever 45, a movement lever 46 and a drive lever 47. The coupling rod 26 is rotatably connected to the joint point 44, the guide lever 45 being rotatably mounted on the first pivot axis 15 and being rotatably connected to the joint point 44. Furthermore, the movement lever 46 is rotatably mounted on the joint point 44 and has a first movement arm 46a and a second movement arm 46b, which are oriented at an angle relative to one another. In addition, the drive lever 47 is arranged on a third pivot axis 48 which is arranged in a stationary manner on the handle support 9 or alternatively on the vehicle door 2. The drive lever 47 is connected to the first movement arm 46a via a joint connection 49, the second movement arm 46b being connected to the first joint axis 16. As can be seen from FIGS. 11 and 12, the third pivot axis 48 is arranged lying between the first pivot axis 15 and the joint connection 49. In the third embodiment, the second lever mechanism 14 is configured exactly as described above for the first and second embodiment, for which reason reference is made to the above description in this regard. With reference to FIG. 11, in the non-actuation position of the handle 4, the second movement arm 46b and the guide lever 45 are arranged at the joint point 44 at an acute angle 50 to one another. The joint connection 49 moves against an opening direction 52 of the handle 4 when the handle 4 moves from the non-use position into the actuation position wherein the joint connection 49 presses the joint point 44 in the direction of the second pivot axis 17. The second movement arm 46b and the guide lever 45 are then arranged at the joint point 44 at an obtuse angle 51 to one another in the actuation position of the handle 4.

In summary, the present invention provides a door handle assembly which, in contrast to the devices known from the prior art, is distinguished by a small installation depth. The door handle assembly described above comprises a handle support which can be secured to the vehicle door, a handle having a longitudinal extension and being mounted on the handle support and arranged so as to run flush with the outer contour of the vehicle door in a non-use position and being designed to be movable into an actuation position by a user for actuation, and a first lever mechanism which is coupled to the first longitudinal end of the handle so as to transmit a movement, and a second lever mechanism which is coupled to the second longitudinal end of the handle so as to transmit a movement, wherein the handle is arranged so as to protrude relative to the outer contour of the vehicle door in the actuation position in comparison to the non-use position and can be actuated by the user in order to open the vehicle door, and wherein the first lever mechanism has a first pivot axis which is arranged on the handle support. According to the invention, the first lever mechanism and the second lever mechanism form a scissor kinematic system, the first and second lever mechanism system being coupled together so as to transmit a movement and tying the handle to the handle support in a mounted manner. According to the invention, the first lever mechanism 11 has two scissor arms (first and third diamond levers 27, 29 in the first embodiment; guide lever 38 and portion 39a of the movement lever 39 in the second embodiment; guide lever 45 and movement arm 46b in the third embodiment) and the second lever mechanism 14 also has two scissor arms (first and second coupling levers 19, 20 in all three embodiments). The scissor arms of the second lever mechanism 14 are arranged at the same angle to one another as the scissor arms of the first lever mechanism 11, wherein this same angle is an acute angle of less than 90° when the handle 4 is arranged in the non-use position, whereas this same angle is an obtuse angle between 90° and 180° when the handle 4 is arranged in the actuation position. The first lever mechanism 11 and the second lever mechanism 14 are connected to one another via the coupling rod 26, one of the two lever mechanisms 11 or 14 being driven by a drive element 37, such that the scissor arms associated with the driven lever mechanism 11, 14 are spread out, as a result of which the coupling rod 26 connected in the joint point spreads the other scissor arms of the non-driven lever mechanism synchronously and, as a result of this spreading, the handle 4 is moved from the non-use position into the actuation position.

The invention described above is, of course, not limited to the embodiments described and depicted. It is evident that numerous modifications can be made to the embodiments shown in the drawing, which are obvious to the person skilled in the art according to the intended application, without leaving the scope of the invention. The invention includes everything that is contained in the description and/or depicted in the drawing, including anything that, deviating from the concrete design examples, is obvious to the person skilled in the art.

1. Door handle assembly of a vehicle door, includes a handle support which can be secured to the vehicle door, a handle having a longitudinal extension and being mounted on the handle support and arranged so as to run flush with the outer contour of the vehicle door in a non-use position and being designed to be movable into an actuation position by a user for actuation, and a first lever mechanism which is coupled to the first longitudinal end of the handle so as to transmit a movement, and a second lever mechanism which is coupled to the second longitudinal end of the handle so as to transmit a movement,
wherein the handle is arranged so as to protrude relative to the outer contour of the vehicle door in the actuation position in comparison to the non-use position and can be actuated by the user in order to open the vehicle door, and
wherein the first lever mechanism has a first pivot axis which is arranged on the handle support,
wherein
the first lever mechanism and the second lever mechanism form a scissor kinematic system and are coupled together so as to transmit a movement.

2. Door handle assembly according to claim 1, wherein the first lever mechanism has a first joint axis which is arranged at the first longitudinal end of the handle and which is coupled to the first pivot axis so as to transmit a movement, wherein the second lever mechanism has a second pivot axis which is arranged on the handle support and a second joint axis which is arranged on the second longitudinal end of the handle and which is coupled to the second pivot axis so as to transmit a movement.

3. Door handle assembly according to claim 2, wherein a first coupling lever is pivotally mounted on the second pivot axis and a second coupling lever is rotatably connected to the second joint axis,
wherein a connecting joint rotatably interconnects the first coupling lever and the second coupling lever, and
wherein when the handle is in the non-use position, the first coupling lever and the second coupling lever are arranged on the connecting joint at an acute angle to one another.

4. Door handle assembly according to claim 3, wherein the first coupling lever and the second coupling lever are arranged on the connecting joint at an obtuse angle relative to one another in the actuation position of the handle.

5. Door handle assembly according to claim 3, wherein the second coupling lever has two lever portions which are interconnected via an intermediate joint, wherein the two lever portions extend linearly in the non-use position and the actuation position, and the two lever portions are designed to be pivotable relative to one another on the intermediate joint in the actuation position as a result of the user actuating the handle.

6. Door handle assembly according to claim 3, wherein the second pivot axis, the first coupling lever, the second coupling lever, the second joint axis and the connecting joint are arranged within the longitudinal extension of the handle, wherein the connecting joint is arranged between the first pivot axis and the second pivot axis.

7. Door handle assembly according to claim 3, wherein the connecting joint is coupled via a coupling rod to the first lever mechanism so as to transmit a movement, wherein the coupling rod is designed to move the connecting joint in the direction of the second pivot axis when the handle moves from the non-use position into the actuation position.

8. Door handle assembly according to claim 7, wherein the first lever mechanism is diamond-shaped and has a first diamond lever, a second diamond lever, a third diamond lever and a fourth diamond lever, wherein the first diamond lever and the second diamond lever are rotatably mounted on the first pivot axis and the third diamond lever and the fourth diamond lever are rotatably mounted on the first joint axis, and wherein the first diamond lever and the third diamond lever are rotatably connected to one another via a first diamond joint axis and the second diamond lever and the fourth diamond lever are rotatably connected to one another via a second diamond joint axis.

9. Door handle assembly according to claim 8, wherein the first pivot axis and the first joint axis are arranged opposite each other in a direction transverse to a longitudinal direction of the handle, wherein the coupling rod is connected to the first diamond joint axis and is movably guided by the second diamond joint axis in the longitudinal direction of the handle.

10. Door handle assembly according to claim 9, wherein when the handle is in the non-use position, both the first diamond lever and the second diamond lever are arranged on the first pivot axis and the third diamond lever and the fourth diamond lever are arranged on the first joint axis at an obtuse angle to each other, wherein when the handle is in the actuation position, both the first diamond lever and the second diamond lever are arranged on the first pivot axis and the third diamond lever and the fourth diamond lever are arranged on the first joint axis at an acute angle to each other.

11. Door handle assembly according to claim 9, wherein the first diamond lever and the third diamond lever are arranged on the first diamond joint axis in the non-use position of the handle and the second diamond lever and the fourth diamond lever are arranged on the second diamond joint axis at an acute angle to one another, wherein the first diamond lever and the third diamond lever are arranged on the first diamond joint axis in the actuation position of the handle and the second diamond lever and the fourth diamond lever are arranged on the second diamond joint axis at an obtuse angle to one another.

12. Door handle assembly according to claim 9, wherein the first lever mechanism is arranged within the longitudinal extension of the handle, wherein the second diamond joint axis is arranged between the first diamond joint axis and the connecting joint.

13. Door handle assembly according to claim 7, wherein the first lever mechanism has a guide lever and a movement lever, wherein the movement lever is rotatably connected to the first joint axis and rotatably connected to a movement axis which is linearly movable on the handle support, and wherein the guide lever is rotatably mounted on the first pivot axis and is rotatably connected to the central portion of the movement lever via a joint point.

14. Door handle assembly according to claim 13, wherein in the non-use position of the handle the guide lever and the portion of the movement lever are arranged between the joint point and the first articulation axis at the joint point at an acute angle to each other, wherein in the actuation position of the handle, the guide lever and the portion of the movement lever connected to the first joint axis are arranged at the joint point at an obtuse angle to one another.

15. Door handle assembly according to claim 13, wherein the joint point is arranged lying between the movement axis and the first pivot axis, the coupling rod being rotatably connected to the joint point, wherein the movement axis moves during a movement of the handle from the non-use position into the actuation position in the direction of the first pivot axis and the movement axis presses the joint point in the direction of the second pivot axis.

16. Door handle assembly according to claim 7, wherein the first lever mechanism has a joint point with which the coupling rod is rotatably connected, a guide lever which is rotatably mounted on the first pivot axis and which is rotatably connected to the joint point, a movement lever which is rotatably mounted on the joint point and has a first movement arm and a second movement arm, and a drive lever which is mounted on a third pivot axis which is arranged on the handle support, wherein the drive lever is connected to the first movement arm via a joint connection, the second movement arm being connected to the first joint axis.

17. Door handle assembly according to claim 16, wherein the first movement arm and the second movement arm are oriented at an angle to one another, wherein in the non-actuation position of the handle, the second movement arm and the guide lever are arranged at the joint point at an acute angle to one another, and wherein in the actuation position of the handle, the second movement arm and the guide lever are arranged at the joint point at an obtuse angle to one another.

18. Door handle assembly according to claim 16, wherein the third pivot axis between the first pivot axis and the joint connection is arranged to be lying, wherein the joint connection moves against an opening direction of the handle when the handle moves from the non-use position into the actuation position and the joint connection presses the joint point in the direction of the second pivot axis.
